(19) United States
(12) Patent Application Publication
(10) Pub. No.: US 2010/0238276 A1
(43) Pub. Date: Sep. 23, 2010

(54) APPARATUS FOR DISPLAYING A STEREOSCOPIC IMAGE

(76) Inventors: Ayako TAKAGI, Kanagawa-ken (JP); Tatsuo Saishu, Tokyo (JP); Kazuki Taira, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/729,876

(22) Filed: Mar. 23, 2010

(30) Foreign Application Priority Data
Mar. 23, 2009 (JP) P2009-070955

(51) Int. Cl. H04N 13/04

(52) U.S. Cl. 348/54; 348/E13.075

(57) ABSTRACT

An elemental image display has a pixel plane on which pixels are aligned with a matrix shape. A lens array has a plurality of birefringence lens aligned with an array shape. Each birefringence lens has an isotropy. A plurality of electrodes is placed between the elemental image display and the lens array. Each electrode is differently connected to a power supply line. A first electrode substrate has a part of the plurality of electrodes. A second electrode substrate has other part of the plurality of electrodes. A longitudinal direction of electrodes of the other part is perpendicular to a longitudinal direction of electrodes of the part. A medium is placed between the first electrode substrate and the second electrode substrate. The medium expresses anisotropy of a refractive index by applying a voltage from the power supply line.

### CROSS-REFERENCE TO RELATED APPLICATIONS

This application is based upon and claims the benefit of priority from Japanese Patent Application No. 2009-70955, filed on Mar. 23, 2009; the entire contents of which are incorporated herein by reference.

### FIELD OF THE INVENTION

The present invention relates to an apparatus for displaying a stereoscopic image, such as a 2D/3D switchable autostereoscopic display or an autostereoscopic display.

### BACKGROUND OF THE INVENTION

Recently, development of an autostereoscopic display (without glasses) is progressed. In many cases, a regular two-dimensional flat display is used. By locating some light control element at a front or back of the display, an angle of a light from the display is controlled using a binocular parallax. Briefly, a stereoscopic image is displayed as if a user views the light emitted from an object located with a distance “several centimeters” at front and rear the display. The reason is, by high-resolution of the display, even if a light from the display is separated into several groups of angle (it is called “parallax”), an image having high-resolution to some extent can be acquired.

As to a content to be displayed, the content is often desired to be displayed as not 3D image but 2D image. Accordingly, by using one display, a technique to display by switching 2D image and 3D image is proposed.

For example in JP No. 3940725 ( . . . Patent reference 1), by rotating a polarization direction using GRIN (gradient index lens), 2D/3D switching is executed. Briefly, a stereoscopic image display apparatus for switching 2D image and 3D image via one display is disclosed.

Furthermore, in WO 2004-538529 (Kokai) ( . . . Patent reference 2), an apparatus for switching 2D/3D image using anisotropic lens and a plane display apparatus (to control a polarization direction) is disclosed. In this reference, a material having birefringence is put into a lens shape, and anisotropic medium is put into a position facing the lens shape. As to a light emitted along a direction having a refractive index difference, 3D image is displayed by collecting the light via lens. As to a light emitted along a direction not having the refractive index difference, 2D image is displayed

In an autostereoscopic display, if a parallax number is smaller, the 3D image has a higher resolution, but a viewing angle to normally view 3D image is narrower. If the parallax number is larger, the viewing angle to normally view 3D image is wider, and a user can view a stereoscopic image from many directions. However, a resolution of the image falls as 1/(parallax number), because the image is divisionally assigned to the parallax number.

On the other hand, by spread of a stereoscopic display of glasses system, a content to be 3D-displayed with binocular parallax is widely popularized. Accordingly, by using one display, at least two 3D images each differently having a parallax, and 2D image, are switched. As a result, each content can be desirably displayed.

However, in the Patent references 1 and 2, as to an autostereoscopic display having 2D/3D switch function, above problem is not taken into consideration. Briefly, display of a binocular parallax content and a multi-view parallax content with high resolution by reducing addition of parts, is not disclosed.

In this case, a method for realizing 3D display having a binocular parallax and a multi-view parallax (Hereinafter, it is called “N parallax”) by the same panel is considered. As to a binocular parallax lens and a multi-view parallax lens, the number of LCD pixels along a lens pitch direction on a back of the lens shape is respectively 2 and N. Briefly, a lens pitch of the N parallax lens is longer N/2 times as a lens pitch of the binocular parallax lens.

If the binocular parallax lens and the N parallax lens are realized by one lens, a gap between a back LCD (to display an elemental image) and each parallax lens is equal. By the principle of the autostereoscopic to emit one elemental image along one direction, a focal distance of the binocular parallax lens is equal to a focal distance of the N parallax lens. Accordingly, a viewing angle of the N parallax lens is approximately larger N/2 times as a viewing angle of the binocular parallax lens, and both lenses cannot realize an arbitrary viewing angle respectively. Furthermore, in order for one lens to ideally realize the binocular parallax lens and the N parallax lens, a lens pitch of the lens itself is necessary to be actively changed.

Furthermore, by laminating the binocular parallax lens and the N parallax lens, both lenses are used. In this case, by locating both lenses at an arbitrary position along a lamination direction, a desired viewing angle can be realized. However, a mechanism to independently operate the binocular parallax lens and the N parallax lens is necessary.

### SUMMARY OF THE INVENTION

The present invention is directed to an apparatus for displaying by switching at least two 3D images each differently having a parallax number and 2D image, with a simple component.

According to an aspect of the present invention, there is provided a 2D/3D switchable autostereoscopic display or an autostereoscopic display, comprising: an elemental image display having a pixel plane on which pixels are aligned with a matrix shape; a lens array having a plurality of birefringence lens aligned with an array shape, each birefringence lens having an isotropy; a plurality of electrodes placed between the elemental image display and the lens array, each electrode being differently connected to a power supply line; a first electrode substrate having a part of the plurality of electrodes; a second electrode substrate having other part of the plurality of electrodes, a longitudinal direction of electrodes of the other part being perpendicular to a longitudinal direction of electrodes of the part; and a medium placed between the first electrode substrate and the second electrode substrate, the medium expressing an anisotropy of a refractive index by applying a voltage from the power supply line.

### BRIEF DESCRIPTION OF THE DRAWINGS

FIG. 1 is a schematic diagram showing a display principle of II system.

FIG. 2 is a schematic diagram showing a stereoscopic image displaying apparatus having 2D/3D switching function.

FIG. 3 is a schematic diagram showing a first director distribution of GRIN lens as two transparent substrates parallel each other.

FIG. 4 is a schematic diagram showing a second director distribution of GRIN lens as two transparent substrates parallel each other.

FIG. 5 is a schematic diagram of an example to multi-lay a GRIN lens.

FIG. 6 is a schematic diagram showing a viewing angle on an autostereoscopic display.

FIG. 7 is a graph showing relationship between a thickness t of a liquid crystal and a viewing angle 2θ.

FIG. 8 is a schematic diagram of an example to realize a binocular parallax lens.

FIG. 9 is a schematic diagram showing a gradient of the director and a refractive index.

FIG. 10 is a schematic diagram of an example to realize N parallax lens.

FIG. 11 is a schematic diagram showing a first director distribution in case of applying a voltage to inter-two interdigitated electrodes on an upper electrode.

FIG. 12 is a schematic diagram showing a first director distribution in case of applying a voltage to inter-two interdigitated electrodes on an upper electrode.

FIG. 13 is a schematic diagram of an example showing a dummy electrode.

FIG. 14 is a schematic diagram of an example showing 2D mode.

FIG. 15 is a table showing whether a voltage is applied for each mode between an upper electrode and a lower electrode.

FIG. 16 is a schematic diagram showing a voltage applied to a polarization switching cell 3 in binocular parallax mode.

FIG. 17 is a schematic diagram showing a voltage applied to a polarization switching cell 3 in N parallax mode.

FIG. 18 is a graph showing a voltage control to realize binocular parallax mode.

FIG. 19 is a graph showing a voltage control to realize N parallax mode.

FIG. 20 is a graph showing a voltage control to realize 2D display mode having high resolution.

FIG. 21 is a schematic diagram of an example to realize a binocular parallax lens in the stereoscopic image display apparatus having a vertical parallax.

FIG. 22 is a schematic diagram of an example to realize N parallax lens in the stereoscopic image display apparatus having a vertical parallax.

FIG. 23 is a schematic diagram of an example to realize 2D mode having high resolution in the stereoscopic image display apparatus having a vertical parallax.

FIG. 24 is a table showing whether a voltage is applied for each mode between an upper electrode and a lower electrode in the stereoscopic image display apparatus having a vertical parallax.

FIG. 25 is a schematic diagram of an example of a lower electrode having supplemental electrodes.

### DETAILED DESCRIPTION OF THE EMBODIMENTS

Hereinafter, embodiments of the present invention will be explained by referring to the drawings. The present invention is not limited to the following embodiments.

A method for recording/regenerating a stereoscopic image, which is called an integral photography method (IP method) to display a large number of parallax images, or a method for homogeneously emitting lights from 3D panel, is well known. When a user views an object with both eyes, an angle between A point (near the user's eye point) and respective (right and left) eye is α, and an angle between B point (far from the user's eye point) and respective (right and left) eye is β. In this case, α and β are different based on a positional relationship between the object and the user, and “α−β” is called a binocular parallax. The user is sensitive to the binocular parallax, and can stereoscopically view with the binocular parallax.

A 3D display method for applying IP method to a display is called an II (integral imaging) method. In the II method, lights emitting from one lens correspond to the number of elemental images. The number of elemental images is called a parallax number. From each lens, a parallax light is approximately emitted in parallel.

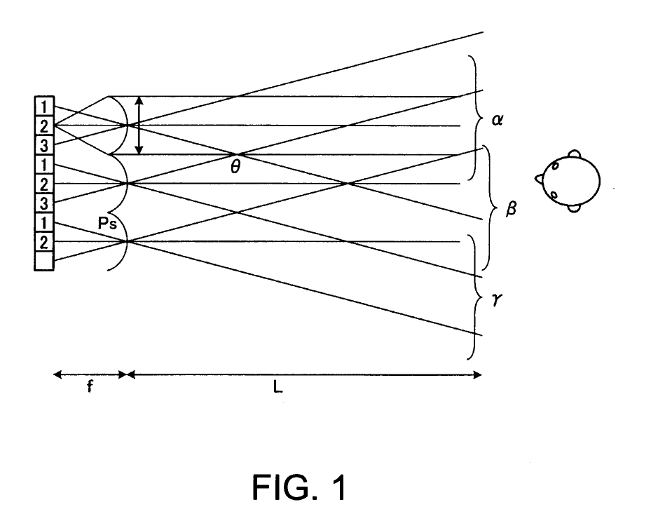

FIG. 1 shows a display principle of II method. Based on a user's position or view angle, the user differently views a monocular parallax image α, a binocular parallax image β, and a tricular parallax image γ. Accordingly, by a parallax sensible with a right eye and a left eye, the user stereoscopically perceives. In case of using a lenticular lens as a light control element, in comparison with a slit, a luminance rises because use efficiency of light is higher. Furthermore, a gap between the lens array and pixels (elemental image) should be approximately equal to a focal distance of the lens. In this case, a light from one pixel is emitted along one direction, and the user can differently view a parallax image based on the user's view angle.

A calcite is most popular as a material having birefringence. As optical application of birefringence, an oriented film used for a phase difference film is known. Furthermore, a liquid crystal has also birefringence.

In the liquid crystal, a molecule has a long and slender shape, and anisotropy of refractive index occurs along a longitudinal direction (director) of the molecule. For example, many molecules in nematic liquid crystal have a long and slender shape, and their major axis directions are aligned. However, positional relation of the molecules is random. Though major axis directions of the molecules are aligned, they are not perfectly in parallel and have a fluctuation to some extent, because the liquid crystal does not have am absolute zero. However, in a local area, the molecules are aligned along the same direction.

Accordingly, an area, which is macroscopically small but sufficiently large compared with a size of a liquid crystal molecule, is considered. In this area, alignment direction of averaged molecule is represented by a unit vector n. A vector representing the alignment direction is called a director or an alignment vector. An alignment which the director is in parallel with a substrate is called a homogeneous alignment. The liquid crystal has an optical anisotropy along a direction perpendicular to a direction parallel with the director. In comparison with another anisotropic medium such as a crystal, a degree of freedom of alignment of molecule is high. Accordingly, a difference (as a standard of birefringence) of refractive index between a major axis and a minor axis is large.

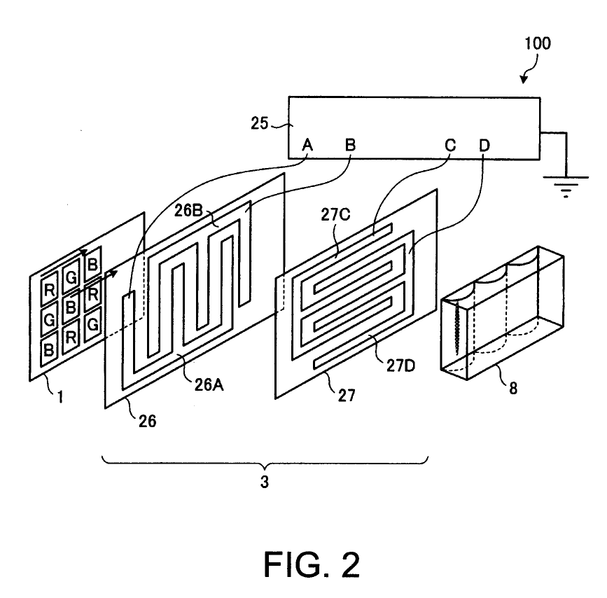

FIG. 2 is a component of a stereoscopic image display apparatus 100 having 2D/3D switching function. The stereoscopic image display apparatus 100 includes a FPD (Flat Panel Display) plane 1, a polarization switching cell 3, a birefringence lens 8, and a voltage driving apparatus 25. By combining the polarization switching cell 3 and the birefringence lens 8, display to switch 2D/3D is possible. Hereinafter, the stereoscopic image display apparatus represents a 2D/3D switchable autostereoscopic display or an autostereoscopic display.

For example, if a LCD is used as the FRD, the FRD plane 1 has pixels and a polarization plane (located on the pixels) to control a luminance of the pixels. The birefringence lens 8 has a lens array-frame having a refractive index n, and a facing substrate. As to the lens array-frame, a lens array has a plurality of lenses. Each lens has a face with a flat shape on the user side, and a face with a recessed and projected shape on the FRD plane side. In a lens part between the lens array-frame and the facing substrate, a birefringence material having isotropy is filled up.

Along a direction parallel to a ridge line of the lens, a refractive index nₑ is expressed (nₑ>n). Along a direction perpendicular to the ridge line, a refractive index n₀ is expressed, and n₀ is approximately equal to nₑ. At the lens array-frame, in case of a horizontal parallax “N” and a sub-pixel pitch “sp”, each lens is formed with a pitch “N×sp”.

The polarization switching cell 3 is set at the front of the FRD plane 1, which can vary a polarization plane. The polarization switching cell 3 includes an upper transparent substrate 27 and a lower transparent substrate 26. The upper transparent substrate 25 is set at a side of the birefringence lens 8. The lower transparent substrate 26 is set at a side of the FRD plane 1.

The upper transparent substrate 27 and the lower transparent substrate 26 respectively have a plurality of transparent electrodes. A distance between each electrode is smaller than a distance d between the upper transparent substrate 27 and the lower transparent substrate 26. A longitudinal direction of electrodes (Hereinafter, they are called “upper electrodes”) on the upper transparent substrate 27 is perpendicular to a ridge line direction of a lens of the birefringence lens 8. Electrodes (Hereinafter, they are called “lower electrodes”) on the lower transparent substrate 26 are set along a direction perpendicular to the longitudinal direction of the upper electrodes.

As to the upper transparent substrate 27 and the lower transparent substrate 26, an alignment direction is perpendicular to the ridge line direction of the lens of the birefringence lens 8. A pitch of the lower electrodes is integral number times as a sub-pixel pitch.

The upper electrodes have two electrodes 27C and 27D, 27C and 27D are mutually located on the upper transparent substrate 27. The lower electrodes have two electrodes 26A and 26B, 26A and 26B are mutually located on the lower transparent substrate 26. The voltage driving apparatus 25 has four terminals A-D, and controls a potential of each electrode 26A, 26B, 27C and 27D.

A method for realizing a plurality of lens types by one lens is explained. In this example, by using a birefringence along an axis direction of a director of the liquid crystal and setting a polarization direction in parallel with the direction, a positional distribution of the refractive index occurs.

By lying interdigitated electrodes on two transparent substrates (parallel each other), electric fields along a horizontal direction and a vertical direction occur. By following equation (1), a retardation Rₑ (x) along Z-direction is considered along a lens pitch direction X.

$$Re ( x ) = d \times {\sum }_{n = 1}^{N} Δ n ( x , {z}_{n} ) \qquad ( 1 )$$

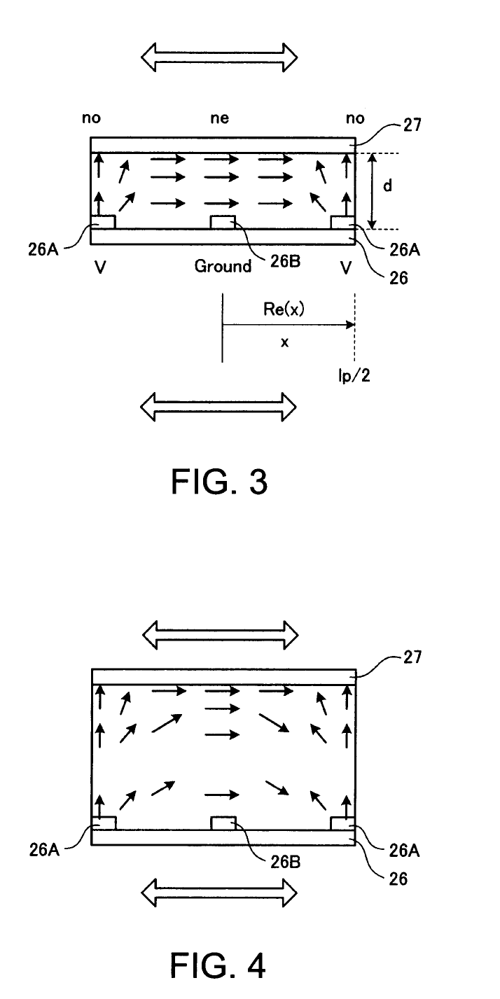

FIG. 3 is a sectional plan of the polarization switching cell 3, which shows a director distribution of GRIN lens of the two transparent substrates (parallel each other). In FIG. 3, both sides 26A of a lower electrode 26 are respectively a power supply, and a center 26B of the lower electrode 26 is a ground. Furthermore, an upper electrode 27 is a ground.

In FIG. 3, by counting a distribution of the retardation along X-direction, the distribution is aligned with a refractive index nₑ along a major axis direction at x=0. Accordingly, the retardation is “(nₑ−n₀)×D”. Furthermore, the distribution is aligned with a refractive index n₀ along a minor axis direction at x=lp/2. Accordingly, the retardation is “0”.

An ideal form of GRIN lens has a distribution n(r) of the refractive index as following equation (2). Furthermore, a focal distance f of a lens having the distribution of the equation (2) is represented as following equation (3).

$$\begin{matrix}n ( r ) = {n}_{e} + ( \frac{{n}_{o} - {n}_{e}}{{r}_{o}^{2}} ) {r}^{2} & ( 2 ) \\ f = \frac{{r}_{o}^{2}}{2 t ( {n}_{e} - {n}_{o} )} & ( 3 )\end{matrix}$$

FIG. 4 is a sectional plan of the polarization switching cell 3, which shows a director distribution of GRIN lens of the two transparent substrates having a thickness different from that in FIG. 3. A factor to affect the director distribution is mainly a distribution of electric field. The electric field is desired so that the distribution of electric field is the director distribution satisfying the equation (2). In detail, a voltage applied to the liquid crystal, anisotropy of permittivity, and an electrode structure (lens pitch/lens thickness), are factors.

For example, in case of using a liquid crystal “K15”, the number of openings is maximized at “(lens pitch/lens thickness)=3”. Under this structure condition, in case of “(lens pitch/lens thickness)=2-3” by a simulation, a lens ability rises. The most suitable value changes by a type of the liquid crystal or a width of electrode. Accordingly, the most suitable value should be determined by an experiment or a simulation.

Under the condition that the lens pitch is 520 um and a thickness of the liquid crystal is 100 um, FIG. 3 shows a director distribution of a crystal having “(lens pitch/lens thickness)=5.20”. In FIG. 3, an area including directors along the horizontal direction is large in a center of the lens. Briefly, a difference between this area and an ideal shape of the lens is large.

On the other hand, under the condition that the lens pitch is 520 um and a thickness of the liquid crystal is 150 um, FIG. 4 shows a director distribution of a crystal having “(lens pitch/lens thickness)=3.46”. In FIG. 4, an area including directors along the horizontal direction is smaller than that of FIG. 3. Briefly, a difference between this area and an ideal shape of the lens is small.

In FIGS. 3 and 4, an electric field applied along the horizontal direction of a liquid crystal cell is same. However, a thickness along the vertical direction is different, and an electric field applied along the vertical direction is different. As to a GRIN lens having interdigitated electrodes with a liquid crystal, a director distribution of the liquid crystal is determined by a distribution of the electric field. Accordingly, an ability of the lens having “(lens pitch/lens thickness) nearer to a constant value” more rises.

In the equation (2), in case that “(lens pitch/lens thickness)=(2×r₀/t)” is constant, a focal distance f is in proportion to r₀/(nₑ−n₀). If a lens pitch r₀ is doubled, the focal distance is also doubled. If a distance between the lens and a back image (elemental image) is fixed at some position, a lens pitch of each lens is different. Accordingly, a focal distance of each lens is difficult to be equal. Briefly, if one GRIN lens is used both as a binocular parallax lens and a N parallax lens, either ability of the binocular parallax lens or ability of the N parallax lens is sacrificed. Accordingly, the GRIN lens is multi-layered.

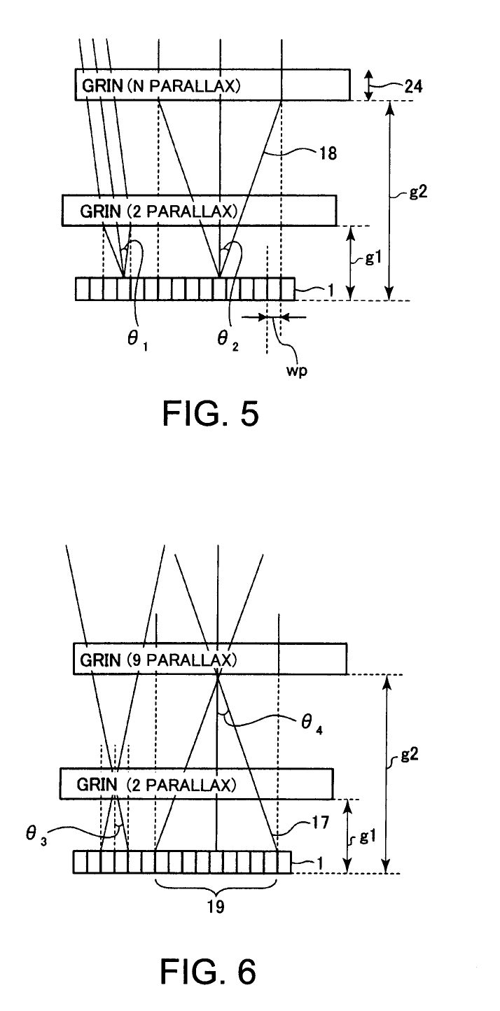

FIG. 5 shows an example which the GRIN lens is multi-layered. In FIG. 5, a GRIN lens of N (>2) parallax is located at the upper side (viewer side), and a GRIN lens of binocular parallax is located at the lower side (opposite side of the viewer). Furthermore, a light from each GRIN lens is converged on a two-dimensional image display apparatus for displaying an elemental image (composing 3D image).

In FIG. 3, a gap g1 is a distance between the GRIN lens (binocular parallax) and the elemental image, a gap g2 is a distance between the GRIN lens (N parallax) and the elemental image, a light 18 is a light refracted by a lens effect, a width Wp is a width of one elemental image on a back FRD, a thickness 24 of the liquid crystal is a thickness og the GRIN lens (N parallax).

For example, in order for the GRIN lens to realize autostereoscopic display (N parallax), in case that width Wp of one sub-pixel is one elemental image, a lens pitch is set to Wp×N.

FIG. 6 shows a viewing angle of the stereoscopic display. In FIG. 6, a light 17 is a parallax light, a gap between the lens and the elemental image is converted to a length g in air through which a light passes in the equivalent time, and a viewing angle to normally view 3D image is 2×θ₄. In this case, following equation (4) is concluded.

tan θ₂=N×wp/2/g (4)

Accordingly, when the parallax number is larger, a power to refract the light at an edge part of the lens is larger. As shown in FIG. 6 compared with FIG. 5, in case that a focal distance of GRIN lens (N parallax) is f2 and a focal distance of GRIN lens (binocular parallax) is f1, g2 is approximately equal to f2. Furthermore, in case that g1 is approximately equal to f1, one pixel on the elemental image can be emitted along a desired direction without dropping a luminance of the one pixel.

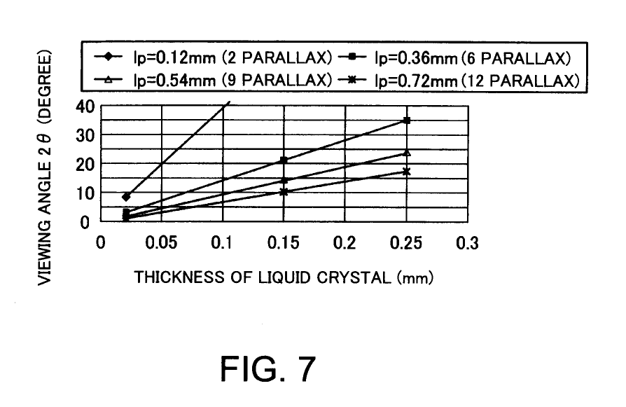

FIG. 7 is a graph showing a relationship between a thickness t of the liquid crystal and a viewing angle 2θ. In FIG. 7, a horizontal axis represents the thickness, and a vertical axis represents the viewing angle. In order to realize the same viewing angle 2θ, when a lens pitch lp is larger, the liquid crystal is thicker. When the thickness is longer than 100 um, it is difficult to control a director at a center part along a thickness direction in the liquid crystal. Accordingly, the liquid crystal is desired to be thin.

As to the GRIN lens having at least nine parallax, in order to realize a stereoscopic display of II system (for a user to naturally view), a thickness of the liquid crystal is, for example, in case of the viewing angle 2θ>20 degree, equal to or larger than 220 um. This thickness often affects ability of the lens.

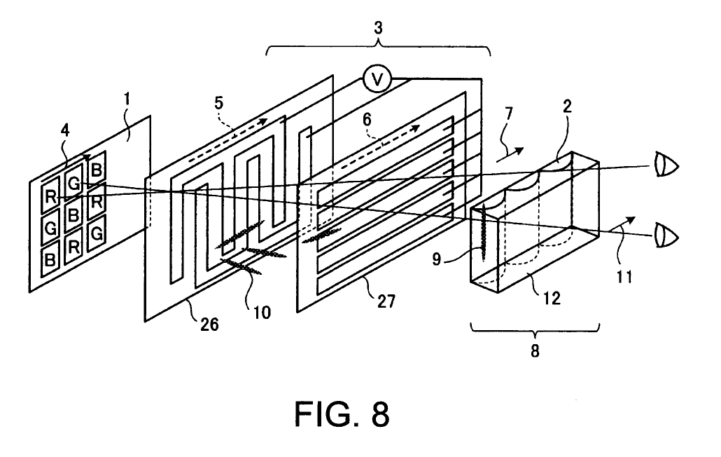

Accordingly, in the present embodiment, a multi-view parallax lens (having at least nine parallax) is created by a birefringence lens (formed by a lens array-frame), and a binocular parallax lens is created by a GRIN lens. FIGS. 8-10 show schematic diagrams to explain switching the binocular parallax lens and the nine parallax lens by one lens. FIG. 8 shows an example of the binocular parallax lens.

In FIG. 8, the binocular parallax lens includes a FRD plane 1, a polarization switching cell 3, and a birefringence lens 8. The FRD plane 1 is a display plane of a two-dimensional display apparatus to display an elemental image. The polarization switching cell 3 switches a binocular parallax mode and a nine parallax mode. The birefringence lens has a lens array-frame in which a liquid crystal is filled up.

An arrow 4 shown in the FRD plane 1 represents a polarization direction at outside of the FRD plane 1. An arrow 5 shown in the polarization switching cell 3 represents an alignment direction (Hereinafter, it is called “lower side alignment direction”) on the lower transparent substrate 26. An arrow 6 shown in the polarization switching cell 3 represents an alignment direction (Hereinafter, it is called “upper side alignment direction”) on the lower transparent substrate 27. An arrow 7 represents a polarization direction of a light emitted from the polarization switching cell 3. Furthermore, a plurality of ellipses represents a major axis direction having a maximum refractive index in the liquid crystal of the polarization switching cell 3.

The birefringence lens 8 includes a lens array-frame 12. A material 2 having isotropic birefringence is filled up into the lens array-frame 12. Furthermore, an arrow 11 represents a polarization direction of a light emitted from the birefringence lens 8.

The polarization direction is the horizontal direction when a light is emitted from the FRD plane 1. In the GRIN lens of the polarization switching cell 3, the light is refracted because the polarization direction is incident along a major axis direction of a liquid crystal. Furthermore, in the birefringence lens 8, the light is not refracted because the polarization direction is incident along a direction perpendicular to a major axis direction of a liquid crystal. A lower electrode of the GRIN lens (included in the polarization switching cell 3) is formed by two interdigitated electrodes 26A and 26B, which are mutually inserted from top and bottom.

Next, a method for applying a voltage is explained. A potential difference between two interdigitated electrodes 26A and 26B is set to V-Ground1, and a voltage is applied as V-Ground1. Furthermore, a potential difference between the lower electrode and the upper electrode is set to V-Ground2, and a voltage is applied as V-Ground2. In this case, a voltage of “Ground1-Ground2” may be the same value or different value. However, Ground1 and Ground2 are necessary to be lower that a threshold voltage Vₜₕ to rise the liquid crystal. Above voltage control is realized by controlling a potential difference between terminals A and B, and terminals C and D of the voltage driving apparatus 2 in FIG. 2.

The upper electrode may be any of the interdigitated electrode and a full electrode, but a voltage Ground2 is equally applied to all electrodes. In FIG. 8, a sectional plan (along a horizontal direction) of the polarization switching cell 3 shows a director distribution of FIG. 4. Briefly, a polarization direction is set to a direction horizontal to a lens pitch direction of lens array. In this case, a distribution of the refractive index occurs as shown in the sectional plan of FIG. 4.

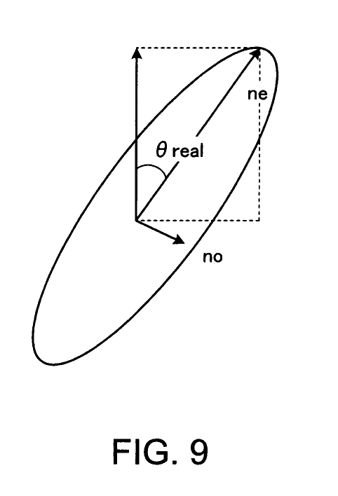

Next, a value of the voltage is explained by referring to FIG. 9. FIG. 9 shows a relationship between a gradient of the director and a refractive index. Actually, the refractive index which a light passes through a birefringence material is represented as follows.

$$N ( {θ}_{real} ) = \frac{{N}_{e} {N}_{o}}{\sqrt{{N}_{e}^{2} {sin}^{2} {θ}_{real} + {N}_{o}^{2} {cos}^{2} {θ}_{real}}} \qquad ( 5 )$$

By the equation (5), a distribution of the refractive index can be occurred by the gradient of the director. Accordingly, the voltage is controlled to satisfy the distribution of the refractive index of the equation (2).

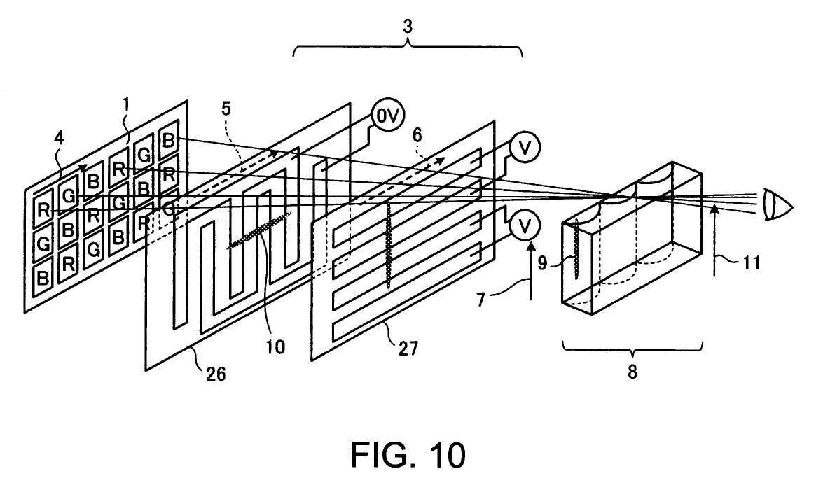

FIG. 10 shows an example of the N parallax lens. In order to express N parallax, in case of viewing the display from a frontal direction, a polarization direction is rotated as 90 degrees from a horizontal direction to a vertical direction. By using the polarization switching cell 3, the polarization direction can be rotated as 90 degrees. In FIG. 10, a direction of an ellipse 10 in the polarization switching cell 3 is along a horizontal direction on the lower transparent substrate 26, and along a vertical direction on the upper transparent substrate 27.

In order to realize this feature, by applying a voltage to inter-upper electrodes, an electric field is caused to be generated. At this time, a voltage to be applied between the lower transparent substrate 26 and the upper transparent substrate 27 is set to be lower than Vₜₕ so that the liquid crystal does not rise along a vertical direction (Hereinafter, this voltage is called “a voltage of inter-facing substrates). Accordingly, the voltage of inter-facing substrates is set to a value lower than Vₜₕ, and a voltage between two upper electrodes on the upper transparent substrate 27 is set to 2×Vₜₕ. As a result, a light from passing through the liquid crystal rising does not occur. Above voltage control is realized by controlling a potential difference between terminals A and B, terminals A and C (or D), and terminals C and D of the voltage driving apparatus 2 in FIG. 2.

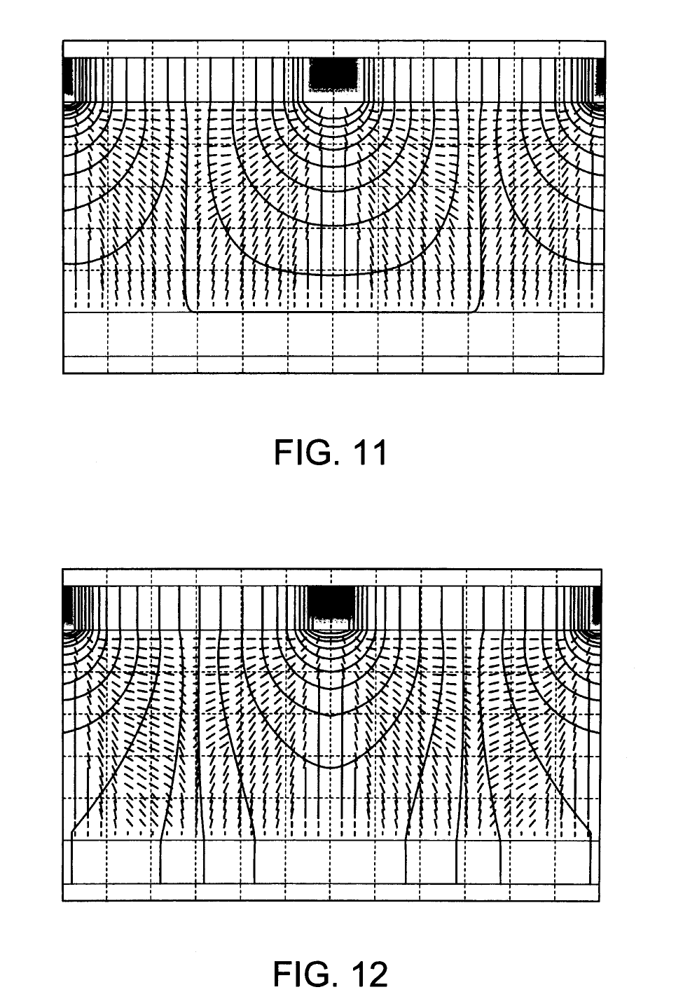

FIGS. 11 and 12 show director distributions, in order to rotate a polarization direction as 90 degrees, in case of applying a voltage 2×Vₜₕ between two interdigitated electrodes of the upper electrode. Briefly, in case of viewing the display from frontal direction, FIGS. 11 and 12 are sectional plans of the polarization switching cell 3 along a vertical direction. FIG. 11 shows an example which a ground electrode is placed at the lower part, and FIG. 12 shows an example which a ground electrode is not placed at the lower part. In this polarization switching mode, a voltage of inter-facing substrates is lower than a threshold voltage, and an alignment power of the liquid crystal in an alignment film is higher than the voltage. Accordingly, the director distribution of the liquid crystal does not change irrespective of the lower electrodes, and the refractive index does not drop.

As to a distance Sp between two upper electrodes, in case that a distance of inter-electrodes is t, the distance Sₚ is set to “Sₚ=t” so that a pitch is narrower compared with the condition of the GRIN lens.

When the interdigitated electrodes are used as the upper electrode on the upper transparent substrate 27, in case of the binocular parallax mode, an area not including the upper electrode exists on the upper transparent substrate 27. If this area is large, even if this area is right above a lower electrode to which the voltage V is applied on the lower transparent substrate 26, a liquid display of this area does not rise.

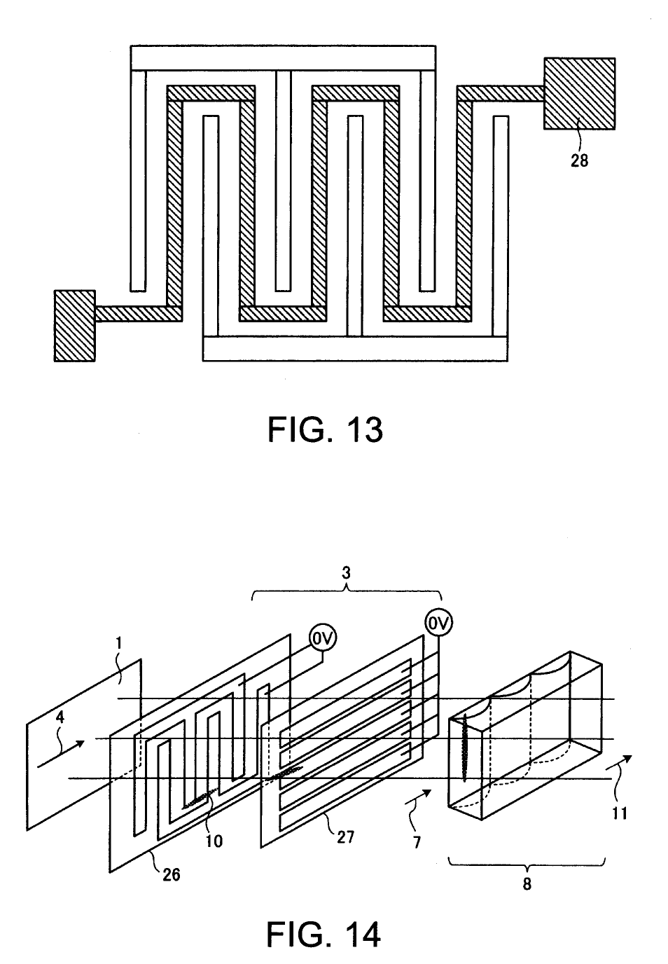

FIG. 13 shows an example that a dummy electrode is set on the upper transparent substrate 27. In case of the binocular parallax mode, the dummy electrode 28 is set between two upper electrodes 27C and 27D, and Ground2 is applied to the dummy electrode 28. In case of the N parallax mode, a potential difference between two interdigitated electrodes may be set to 2×Vₜₕ without applying a voltage to the dummy electrode 28. In case of the binocular parallax mode, as to a part not including the upper electrode on the upper transparent substrate 27, if the part is right above a lower electrode to which the voltage V is applied on the lower transparent substrate 26, a director of a liquid crystal is rising by symmetrical distribution (right and left) of the electric field.

Furthermore, a thickness of the liquid crystal is set based on Morgan condition, which a light leakage is minimized when a polarization direction is rotated as 90 degrees. Briefly, the thickness d is calculated to satisfy following equations (6) and (7).

$$\begin{matrix}u = \frac{2 Δ nd}{λ} & ( 6 ) \\ m π = \frac{π \sqrt{1 + {u}^{2}}}{2} ( m = 1 , 2 , 3 , 4 … ) & ( 7 )\end{matrix}$$

In the equations (6) and (7), λ is a wavelength of a light incident upon the polarization switching cell 3, and Δn is a difference of refractive index between a major axis direction and a minor axis direction of a liquid crystal in the polarization switching cell 3.

FIG. 14 shows an example of 2D mode. A potential difference between two lower electrodes 26A and 26B is “0”, and a potential difference between two upper electrodes 27A and 27B is “0”. As shown in FIG. 14, a voltage is not applied to both the upper electrode and the lower electrode of the polarization switching cell 3. In this case, a polarization direction does not change, and a distribution of the refractive index does not occur. Accordingly, a polarization along a direction perpendicular to the director direction of the liquid crystal is incident upon the birefringence lens 8, and the light is not refracted at the birefringence lens 8. As a result, a user can view 2D image having high resolution displayed on the back plane.

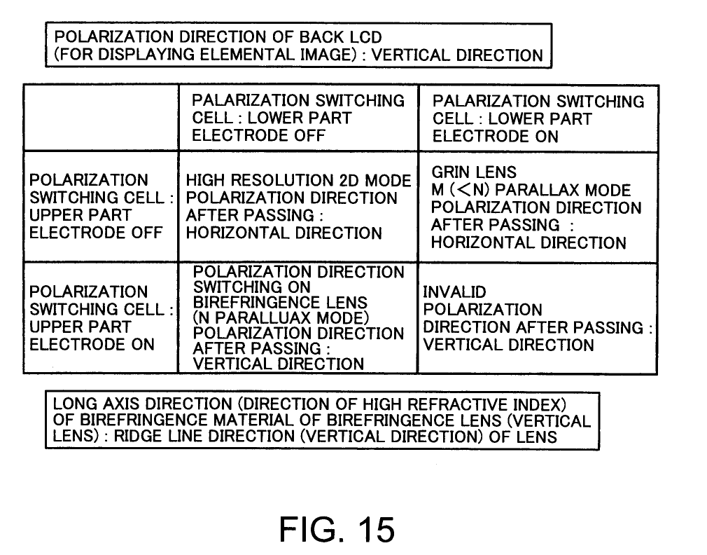

FIG. 15 is a table showing whether a voltage is applied for each mode between the upper electrode and the lower electrode of the polarization switching cell 3. In FIG. 15, the case to apply a voltage is represented as “ON”, and the case not to apply a voltage is represented as “OFF”. By “ON” and “OFF” of the voltage to apply to the upper electrode and the lower electrode, three modes (MVN) parallax mode, N parallax mode, 2D display mode) can be realized by one display.

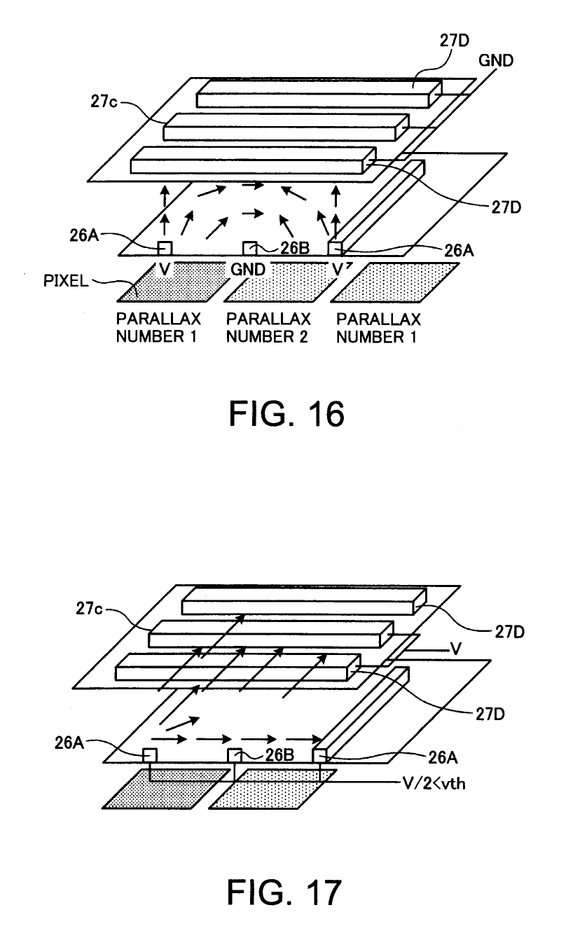

FIGS. 16 and 17 are schematic diagrams to explain a voltage applied to the polarization switching cell 3. FIG. 16 shows an example of the binocular mode, and FIG. 17 shows an example of the N parallax mode. In FIG. 16, a potential of two upper electrodes 27C and 27D is set to Ground, a voltage of the lower electrode 26A is set to V, and a voltage of the lower electrode 26B is set to Ground. In this case, a director of the liquid crystal is represented as an arrow shown in FIG. 16, and the GRIN lens can be realized.

In FIG. 17, a potential difference between two upper electrodes 27C and 27D is set to V, a voltage difference between two lower electrodes 26A and 26B is set to 2/V. In this case, the birefringence lens having N parallax mode can be realized.

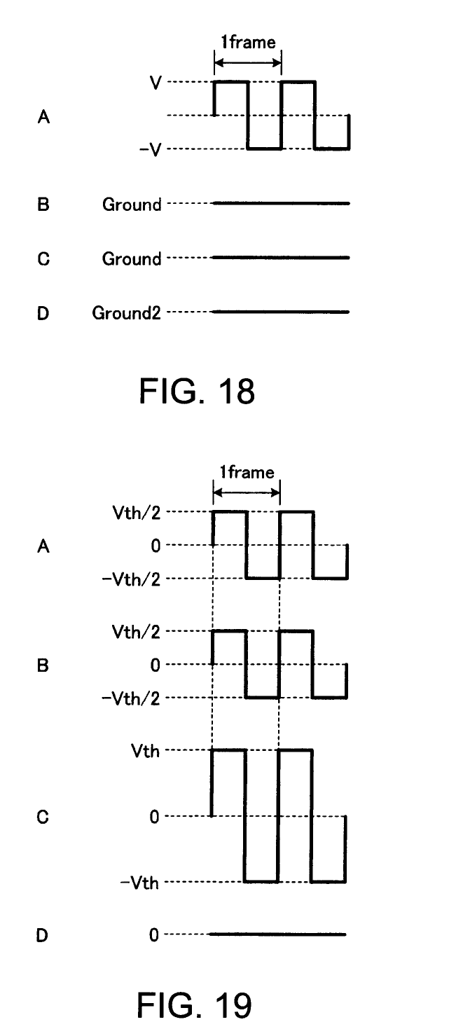

FIG. 18-20 are graphs to explain a potential applied to each terminal of the voltage driving apparatus 25. FIG. 18 is one example of voltage control to realize the binocular parallax mode. As shown in FIG. 18, a potential of the lower electrode 26A is set as a rectangle signal having amplitude V on condition that one frame of a display plane is one period. A potential of other terminals B, C and D are set to Ground. In this case, a display having parallax of right and left can be realized.

FIG. 19 is one example of voltage control to realize the N parallax mode. In FIG. 19, by terminals A and B, a potential of the lower electrodes 26A and 26B are controlled to be equally a rectangle signal having amplitude Vₜₕ/2 on condition that one frame of the display plane is one period. Furthermore, by a terminal C, a potential of the upper electrode 27C is set as a rectangle signal having amplitude V. By a terminal D, a potential of the upper electrode 27D is set to Ground. In this case, a display having N parallax can be realized.

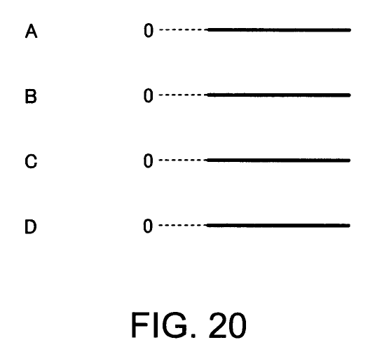

FIG. 20 is one example of voltage control to realize 2D display mode with high resolution. In FIG. 29, a potential of all terminals are equally set to Ground.

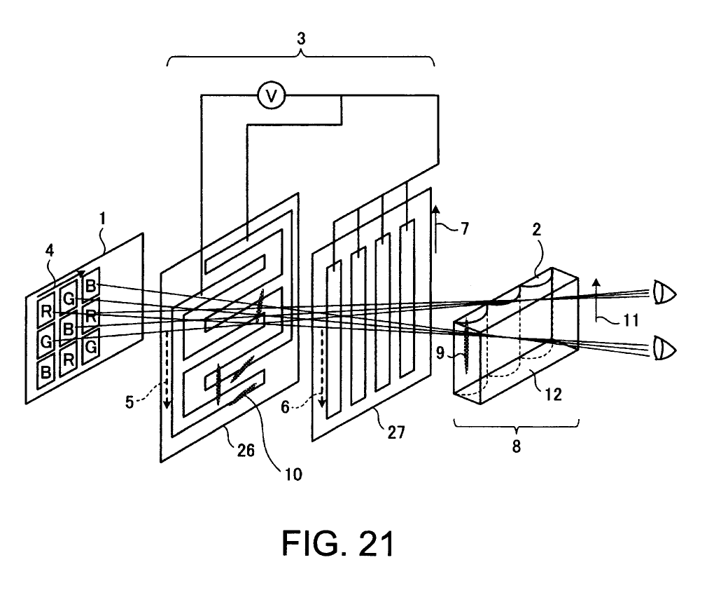

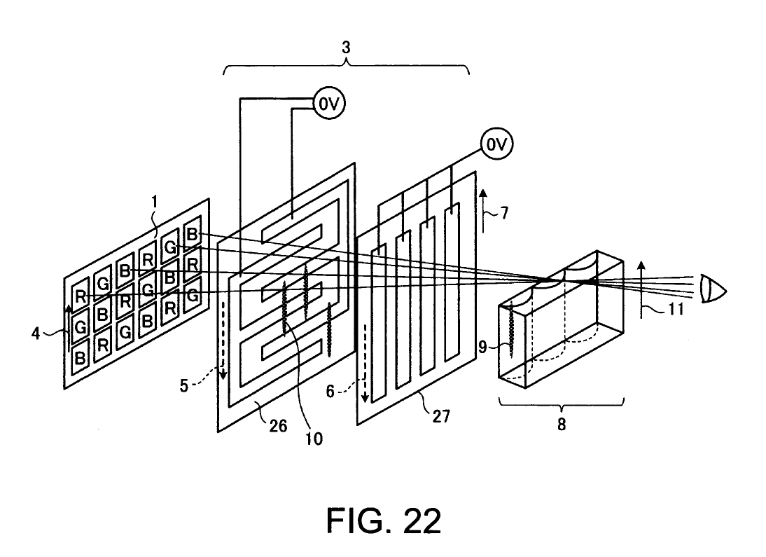

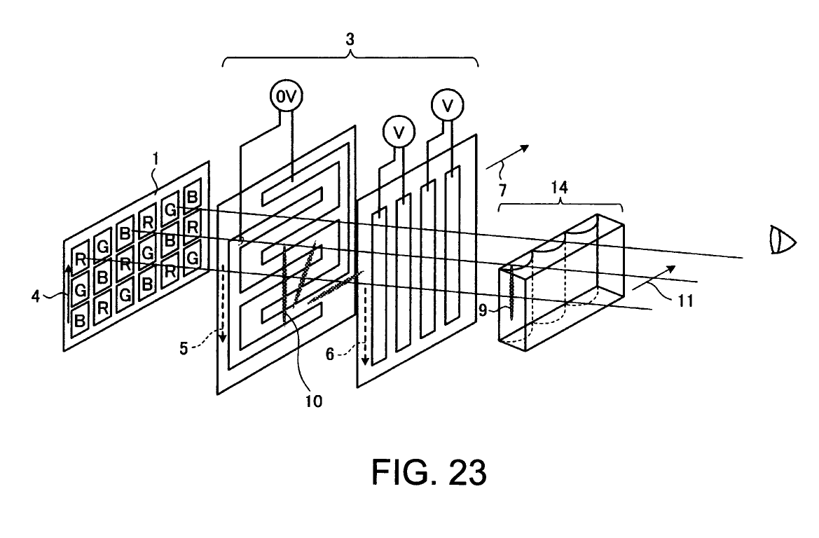

FIG. 21-24 are examples of the stereoscopic image display apparatus to realize a vertical parallax. FIG. 21-23 are respectively an example of the binocular parallax mode, the N parallax mode, and the 2D display mode. In FIG. 21-23, interdigitated electrodes on the lower transparent substrate 26 and the upper transparent substrate 27 are rotated as 90 degrees in comparison with interdigitated electrodes included in the stereoscopic image display apparatus 100 shown in FIGS. 8, 10 and 14, respectively. Other component is same as that of FIGS. 8, 10 and 14. Accordingly, its explanation is omitted.

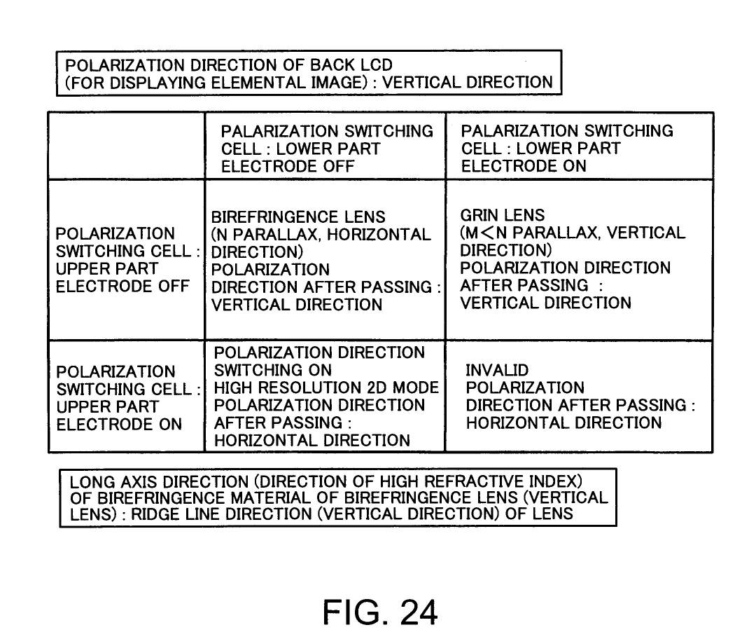

FIG. 24 is a table showing whether a voltage is applied for each mode between the upper electrode and the lower electrode of the polarization switching cell 3. In FIG. 24, the case to apply a voltage is represented as “ON”, and the case not to apply a voltage (the case of Ground) is represented as “OFF”. By “ON” and “OFF” of the voltage to apply to the upper electrode and the lower electrode, three modes (M(<N) parallax mode of vertical parallax, N parallax mode of vertical parallax, 2D display mode) can be realized by one display.

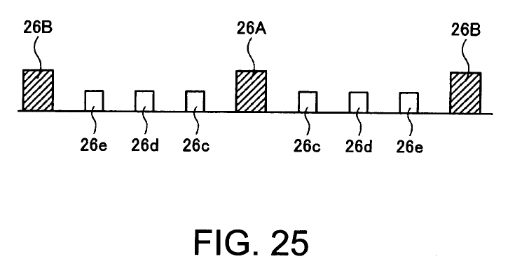

FIG. 25 is an example of the lower electrode including a supplemental electrode. In addition to the interdigitated electrode explained in FIG. 1-24, the lower electrode of FIG. 25 includes the supplemental electrode. In FIG. 25, between the lower electrodes 26A and 26B, three supplemental electrodes 26c-26e are located in nearer order from the lower electrode 26A.

In case of the binocular parallax mode, for example, a potential of the lower electrode 26A is V, and a potential of the lower electrode 26B is Ground. Furthermore, a potential of the supplemental electrode 26c-26e is a value between V and Ground, and controlled to be larger when the supplemental electrode is nearer to the lower electrode 26A. Briefly, V≧(potential of 26c)≧(potential of 26d)≧(potential of 26e)≧Ground. Accordingly, a potential difference between the lower electrodes 26A and 26B are controlled more finely, and the director can be adaptively controlled.

The number of the supplemental electrodes between two adjacent lower electrodes had better be fixed. In FIG. 25, three supplemental electrodes are located every space between two adjacent lower electrodes. If the number of the supplemental electrodes every space is k, the number of electrodes on the lower transparent substrate 26 included in one GRIN lens is (2k+3). Furthermore, the supplemental electrode may be located every space between two adjacent upper electrodes.

(Realization by a Computer)

In the disclosed embodiments, for example, the voltage driving apparatus 25 of the stereoscopic image display apparatus 100 may be realized by a personal computer (PC) and so on. Furthermore, as to the method for controlling a display of the stereoscopic image display apparatus 100, for example, according to a program stored in a ROM or a hard disk apparatus, the CPU executes using a main memory (such as a RAM) as a work area.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. A 2D/3D switchable autostereoscopic display or an autostereoscopic display, comprising:
an elemental image display having a pixel plane on which pixels are aligned with a matrix shape;
a lens array having a plurality of birefringence lens aligned with an array shape, each birefringence lens having an isotropy;
a plurality of electrodes placed between the elemental image display and the lens array, each electrode being differently connected to a power supply line;
a first electrode substrate having a part of the plurality of electrodes;
a second electrode substrate having other part of the plurality of electrodes, a longitudinal direction of electrodes of the other part being perpendicular to a longitudinal direction of electrodes of the part; and
a medium placed between the first electrode substrate and the second electrode substrate, the medium expressing an anisotropy of a refractive index by applying a voltage from the power supply line.

2. The display according to claim 1, wherein
a distance of inter-electrodes of the part on the first electrode substrate is shorter than a distance between the first electrode substrate and the second electrode substrate, and
a distance of inter-electrodes of the other part on the second electrode substrate is shorter than the distance between the first electrode substrate and the second electrode substrate.

3. The display according to claim 1, further comprising:
a potential controller configured to control a potential of each of the plurality of electrodes differently connected to the power supply line.

4. The display according to claim 3, wherein
the potential controller controls each electrode of the part on the first electrode substrate to equally have a potential, and controls each electrode of the other part on the second electrode substrate to differently have a potential.
